(19) United States
(12) Patent Application Publication
(10) Pub. No.: US 2015/0088578 A1
(43) Pub. Date: Mar. 26, 2015

(54) PROJECT MANAGEMENT ALERTS USING HETEROGENEOUS PROJECT DATA

(71) Applicant: Oracle International Corporation, Redwood Shores, CA (US)

(72) Inventors: David Wayne NOWAKOWSKI, Thornton, CO (US); Scott Gene BUSS, Centennial, CO (US); Michael Donald EIDE, Lafayette, CO (US); Beverly Lynn NICOL, Lafayette, CO (US); Lynn J. KELLEHER, Conifer, CO (US); Deborah Marie LIVINGSTON, Littleton, CO (US); Maria Leonor CABALLERO RUIZ, Denver, CO (US); John David BILTHUIS, Highlands Ranch, CO (US); David John SCOTT, Denver, CO (US)

(73) Assignee: Oracle International Corporation, Redwood Shores, CA (US)

(21) Appl. No.: 14/188,341

(22) Filed: Feb. 24, 2014

Related U.S. Application Data
(60) Provisional application No. 61/880,741, filed on Sep. 20, 2013.

(51) Int. Cl. G06Q 10/06

(52) U.S. Cl. CPC G06Q 10/06313
USPC 705/7.23

(57) ABSTRACT

A method, system, and computer program product for enterprise systems and applications. Embodiments commence upon identifying a first account ledger of first data items and a second account ledger of second data items, then identifying a first data item that is stored in a first unit of measurement (e.g., US Dollars), and further identifying a second data item that is stored in a second unit of measurement (e.g., Euros). Configuration steps associate relationships or calculations (e.g., sums, maximums, conversions, etc.) between the first data item and the second data item. When the value of the first data item or the value of the second data item is changed (e.g., by a user-changed value or by a calculation affecting the data item), then alert logic is invoked. When the relationship between the first data item and the second data item is outside of a pre-calculated range then an alert is raised.

### RELATED APPLICATIONS

The present application claims the benefit of priority to U.S. Provisional Patent Application Ser. No. 61/880,741, entitled “PROJECT MANAGEMENT ALERTS USING HETEROGENEOUS PROJECT DATA” (Attorney Docket No. ORA140361-US-PSP), filed Sep. 20, 2013, which is hereby incorporated by reference in its entirety.

### FIELD

The disclosure relates to the field of enterprise systems and applications and more particularly to techniques for project management alerts using heterogeneous project data.

### BACKGROUND

Day-by-day, business is becoming more and more globalized. Historically, projects (e.g., building projects, defense projects, product development projects, software development projects, etc.) have been performed substantially locally, and project management such as cost accounting has been provided locally as well. Yet, in the globalized economies of today, performance of portions of a project and decision-making pertaining to a project might be performed in various locations, including in different countries. Different countries may use different project management and project accounting techniques (e.g., cost basis, accrual basis, etc.), and/or different measurement units (e.g., kilograms, pounds, etc.), and/or different currency units (e.g., dollars, yen, etc.).

A project manager would want to receive an alert when some threshold or limit has been reached (e.g., dollars expended), or a milestone reached (e.g., number of square feet of foundation poured). Even if the project manager set a limit of $1,000,000 dollars to be spent on capital equipment, and the staff in Germany just spent [symbol] 733,000 euros on capital equipment, the project manager would still want to receive an alert, even though the number “733,000” is less than “1,000,000”.

Still worse, a particular project might have a large number of accounts (e.g., a capital expense account, depreciation accounts, manpower accounts, bank accounts, etc.), and/or a large number of spending limits to manage which makes the task of managing a portfolio of projects is even more challenging. Especially when a project comprises or touches a large volume of accounts, a project manager needs alerts in order to be able to quickly identify activity affecting an account (e.g., so remedial action can be taken). However, with a large number of accounts, the problem is akin to the task of “finding a needle in a haystack”.

Legacy project management applications, and legacy project accounting software systems fail to account for differing units and/or other disparities in heterogeneous data when calculating alerts and thresholds for alerts. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for project management alerts using heterogeneous project data.

Embodiments commence upon identifying a first account ledger of first data items and a second account ledger of second data items, then identifying a first data item that is stored in a first unit of measurement (e.g., US Dollars), and further identifying a second data item that is stored in a second unit of measurement (e.g., Euros). Configuration steps associate relationships or calculations (e.g., sums, maximums, conversions, etc.) between the first data item and the second data item. When the value of the first data item or the value of the second data item is changed (e.g., by a user-changed value or by a calculation affecting the data item), then alert logic is invoked. When the relationship (e.g., sum) between the first data item and the second data item is outside of a pre-calculated range or value (e.g., balance overdrawn), then an alert is raised. The relationship between the first data item and the second data item can comprise any number of alert threshold values. The relationships and/or calculations between the first data item and the second data item can comprise a currency exchange rate.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts activities under a project and a user engaged in project management activities including viewing project management alerts using heterogeneous project data, according to some embodiments.

FIG. 1B depicts an environment including an application server for implementing project management alerts using heterogeneous project data, according to some embodiments.

FIG. 1C depicts a flow chart for managing a project having heterogeneous project data, according to some embodiments.

FIG. 2 depicts a system including multiple enterprise applications and a project management application that share account data for implementing project management alerts using heterogeneous project data, according to some embodiments.

FIG. 3A depicts a flow used in systems for implementing project management alerts using heterogeneous project data, according to some embodiments.

FIG. 3B depicts an operation flow based on a received object as used to form project management alerts using heterogeneous project data, according to some embodiments.

FIG. 3C depicts an operation flow to evaluate account data items as used when forming project management alerts using heterogeneous project data, according to some embodiments.

FIG. 4 depicts a configuration flow used to configure project management alerts using heterogeneous project data, according to some embodiments.

FIG. 5 is a screen display showing alerts in the form of row highlights as used in displays output from systems implementing project management alerts using heterogeneous project data, according to some embodiments.

FIG. 6 is a screen display showing a summary of alerts including a pop-up as used with systems implementing project management alerts using heterogeneous project data, according to some embodiments.

FIG. 7 is a block diagram of a system for project management alerts using heterogeneous project data, according to some embodiments.

FIG. 8 is a block diagram of a system for project management alerts using heterogeneous project data, according to some embodiments.

FIG. 9 depicts a block diagram of an instance of a computer system suitable for implementing an embodiment of the present disclosure.

### DETAILED DESCRIPTION

Some embodiments of the present disclosure address problems pertaining to managing multiple activities within a project, and some embodiments are directed to approaches for forming project management alerts. More particularly, disclosed herein and in the accompanying figures are exemplary environments, methods, and systems for project management alerts using heterogeneous project data.

### Overview

A project manager needs to be able to easily interpret project status, even though the project status might derive from disparate data sources. A technique to receive values from different sources (e.g., in different measurement or reporting units), and to reconcile those differing values is needed. This need becomes exacerbated inasmuch as business continues to become more and more globalized. Historically, projects (e.g., building projects, defense projects, product development projects, software development projects, etc.) have been performed substantially locally, and project management such as cost accounting was provided locally as well. Yet, in the globalized economies of today, performance of portions of a project and decision-making pertaining to a project might be performed in various locations, including in different countries. Different countries may use different project management and project accounting techniques (e.g., cost basis, accrual basis, etc.), and/or different measurement units (e.g., kilograms, pounds, etc.), and/or different currency units (e.g., dollars, yen, etc.). A project manager would want to receive an alert when some threshold or limit has been reached (e.g., dollars expended), or a milestone reached (e.g., number of square feet of foundation poured). If the project manager set a limit of $1,000,000 dollars to be spent on capital equipment, and the staff in Germany just spent [symbol] 733,000 euros on capital equipment, the project manager would want to receive an alert (even though the number “733,000” is less than the number “1,000,000”). A technique to receive values in different measurement or reporting units, to reconcile those differing values, and to compare the reconciled values (e.g., converted values, normalized values) to a normalized threshold value or alert value is needed.

Indeed, managing a single complex project is a challenge for any project manager. A particular project might have a large number of underlying accounts (e.g., a capital expense account, depreciation accounts, manpower accounts, bank accounts, etc.). The task of managing a portfolio of projects is even more challenging, yet it is essential to be able to understand and assess the state of their business at any point in time. Even when a project comprises or touches a large volume of accounts, a project manager needs alerts in order to be able to quickly identify activity affecting an account (e.g., so remedial action can be taken). However, with a large number of accounts, the problem is akin to the task of “finding a needle in a haystack”.

In addition to the problem caused by the volume of data, the fact that projects are managed in many different measurement units and currencies makes analyzing the amounts at the account level overwhelming to a project manager.

The solutions described herein encompass multiple use models, many different functions, and many different techniques for raising alerts. Strictly as examples of operations over account ledgers (e.g., an account of transactions stored in a data structure):
Any given alert can be created to evaluate against not only a single account ledger balance, but also a given alert can be created to evaluate against user-defined formulas that can be based on values from multiple account ledgers and/or numeric factors.
Some embodiments include the ability to create alerts that have multiple thresholds, possibly factoring in conversions for data items that are stored in different units (e.g., weight in pounds, mass in kilograms, currency and denomination differences, etc.).
Some embodiments include the ability to create formulas using currency exchange rates that can be applied over values taken from multiple account ledgers stored in different denominations.
In some cases, a given alert can be created to cause evaluation against an external user-defined account or data structure.
Each alert can be associated with a set of account ranges against which it will be evaluated. This allows an alert to be targeted to specific account types, for example, accounts might be numbered in accordance with a hierarchical numeration scheme such that the first few digits or characters of an account name might refer to (for example) a capital equipment account, and the next few digits or characters refer to a sub-classification within that capital equipment account (e.g., 10 year depreciation), and so on.
Raised alerts can be visually indicated by the presence of visual indicators (e.g., row colorizations, icons at the column and row level, etc.) whenever a threshold has been reached. Different visual indications can be provided for respective alert levels. Further, the data presented in the application can be filtered so as to only show accounts in an alert state.

In exemplary embodiments, the project manager performs some configuration steps, and, once configured, even tens of thousands of accounts (or more), any of which comprise data stored in differing units can be managed, and summarized for ease of identifying accounts that are in need of project management attention. Configuration can comprise identifying ledgers, any of which might comprise data items using disparate units of measurement, and then defining a relationship between a first data item (e.g., in one unit of measurement) and a second data item (e.g., in a second unit of measurement).

Continuously or periodically during progression of the project, alert conditions, possibly including applying thresholds are considered, and if the alert is raised (e.g., when the relationship between the first data item and the second data item is outside of a pre-calculated range or value) then an indication (e.g., a visual indication) is emitted.

Projects can include many geographically distant activities, any activity having many project accounting ledgers; the herein-disclosed systems can nevertheless reconcile differences in measurements and/or currencies. Such projects and systems for project management are further described below and in the accompanying figures.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

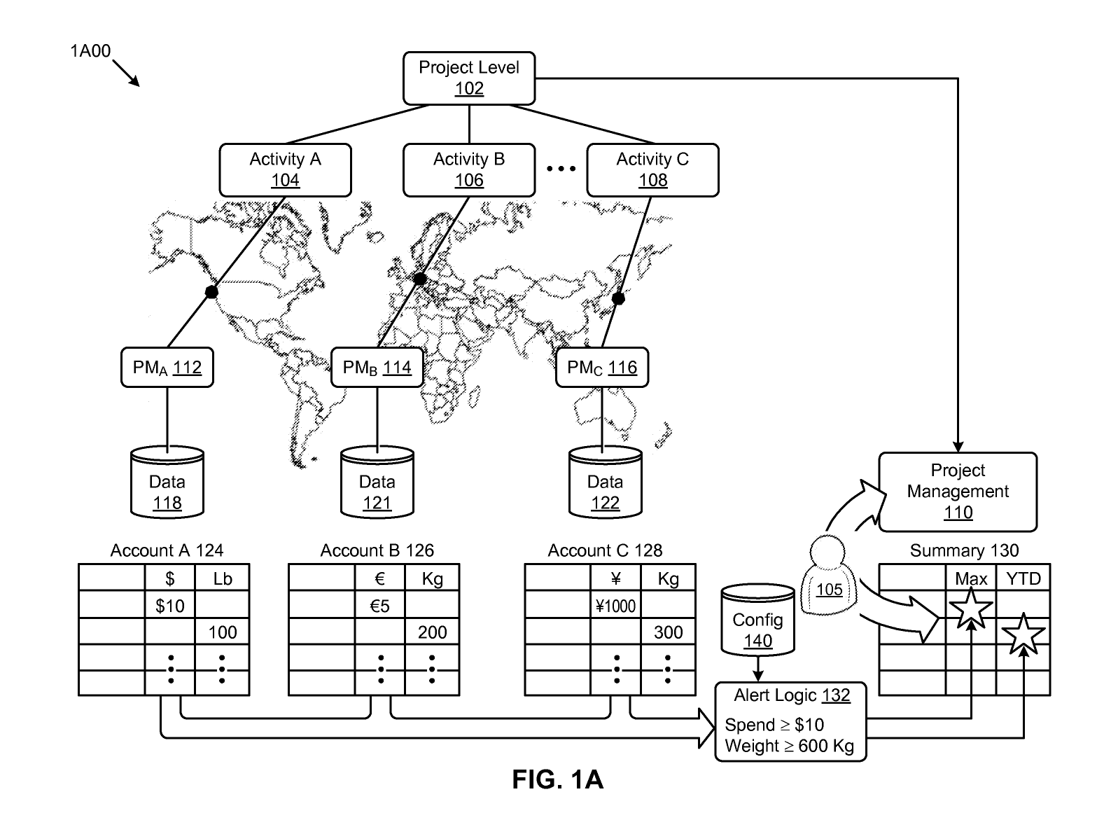

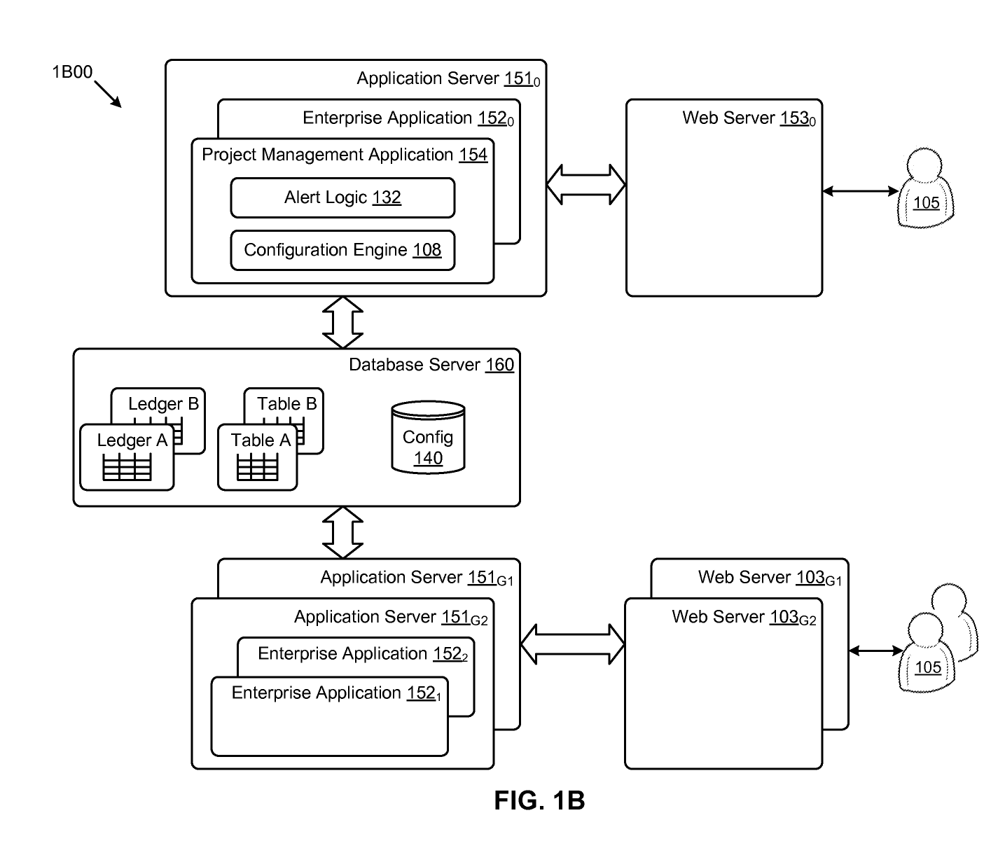

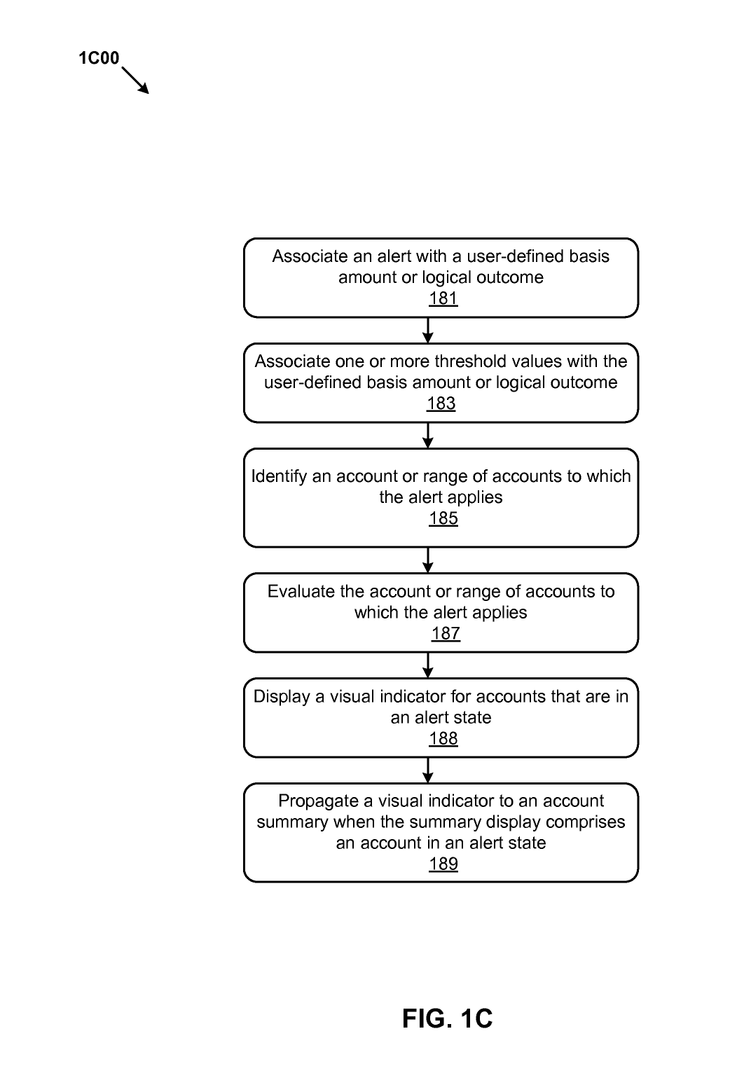

FIG. 1A depicts activities under a project 1A00 and a user engaged in project management activities including viewing project management alerts using heterogeneous project data. As an option, one or more instances of project 1A00 or any aspect thereof may be implemented in the context of the architecture and functionality of the embodiments described herein. Also, the project 1A00 or any aspect thereof may be implemented in any desired environment.

As shown, a project is organized into a hierarchy having a project level 102, which in turn has several project activities (e.g., activity A 104, activity B 106, activity C 108, etc.). In this illustration, the various project activities are geographically distant. As shown, activity A 104 is centered in the United States of America, activity B 106 is centered in the European Union, and activity C 108 is centered in Japan. Each activity in each geography manages its own set of aspects of the overall project, and a project manager (e.g., PM_{A} 112, PM_{B} 114, PM_{C} 116) assigned to each activity manages its own activities. A local project manager interacts with local project resources (e.g., employees, suppliers, customers, etc.), and data items pertaining to the project are stored (e.g., in data_{A} 118, data_{B} 121, data_{C} 122, etc.). In some cases a local project manager might interact with a localized enterprise application in order to record and otherwise manage the progression of the project. Enterprise applications might include an enterprise resource planning (ERP) application, and/or a budgeting application, and/or an accounts payable application, and/or an accounts receivable application, etc. Data items pertaining to the project (e.g., in data_{A} 118, data_{B} 121, data_{C} 122, etc.) can be stored in accounts (e.g., account A 124, account B 126, account C 128, etc.), which in turn can be represented in data structures such as arrays, and/or relations (e.g., in a relational database), and/or as tables (as shown), and an account representation can include a ledger, which in turn can include a ledger balance.

A local project manager might want to monitor the progression of the project using the stored data items. For example, a local project manager (e.g., a local project manager situated in Seattle, Wash.) might want to know how many project dollars have been spent on “consulting services” and/or might want to know how many pounds of “powdered magnesium” have been consumed on-site since the beginning of the year. Similarly, a local project manager (e.g., a local project manager situated in Toulouse, France) might want to know how many euros have been spent on “consulting services” and/or might want to know how many kilograms of “powdered magnesium” have been consumed on-site since the beginning of the year. Similarly, a local project manager (e.g., a local project manager situated in Tokyo, Japan) might want to know how many yen have been spent on “consulting services” and/or might want to know how many kilograms of “powdered magnesium” have been consumed since the beginning of the year. As can now be noted, each activity might manage and store data items in units that are convenient for that locale (e.g., dollars, euros, yen, pounds, kilograms, etc.).

Also shown in FIG. 1A is an instance of alert logic 132 that takes as inputs data item values from several tables or other account representations (e.g., account A 124, account B 126, account C 128, etc.), as well as inputs in the form of configurations (e.g., config 140), and produces alerts based on thresholds. Any number of inputs, thresholds and alerts can be defined and rolled-up into a summary 130. As shown, the alert logic normalizes data item values (e.g., based on the local units of measurement) and summarizes the normalized data in a summary display.

Any of the aforementioned applications can be implemented in an application server. An illustrative environment includes multiple application servers, a database server, and middleware to host interfaces (e.g., web servers) situated between a user and applications.

FIG. 1B depicts an environment 1B00 including an application server for implementing project management alerts using heterogeneous project data. As an option, one or more instances of environment 1B00 or any aspect thereof may be implemented in the context of the architecture and functionality of the embodiments described herein. Also, the environment 1B00 or any aspect thereof may be implemented in any desired environment.

As shown, environment 1B00 comprises an application server 151₀ that hosts any number of applications (e.g., enterprise application 152₀, project management application 154, etc.). The application server 151₀ stores data to a database (e.g., in a database server 160) which in turn stores data that is represented in data structures such as arrays and/or relations and/or as tables (e.g., table A and table B). Other application servers can access the database server 160. For example application server 151_{G1} might be installed in Seattle, and application server 151_{G2} might be installed in Tokyo, and both can access the database server 160. Moreover an application server can host any number of enterprise applications (e.g., enterprise application 152₀, enterprise application 152₁, enterprise application 152₂, project management application 154, etc.).

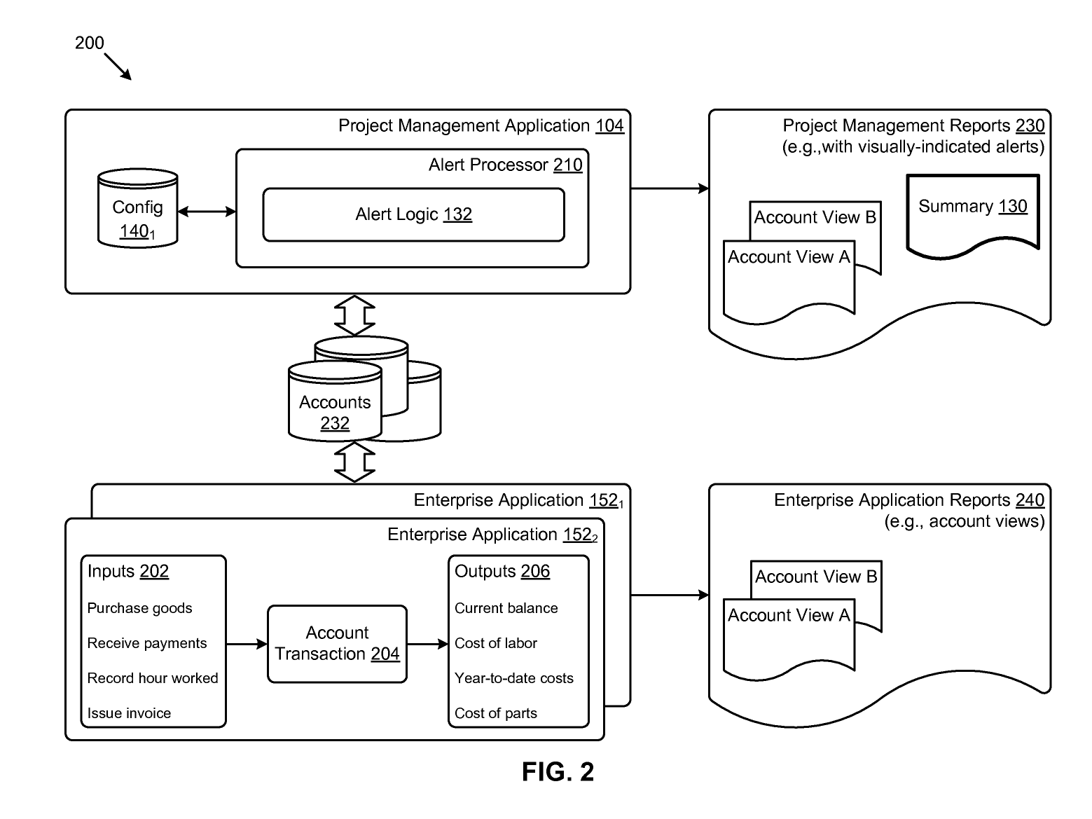

To facilitate user interaction, middleware components may be provided in any geography (e.g., web server 153₀, web server 153_{G1}, web server 153_{G2}, etc.). In particular, a project management application 154 can be deployed in any geography and/or run on any application server, and interface with any middleware component. Similarly, project accounts and any constituent data items stored in database server 160 can be shared (e.g., for READ, WRITE and/or other accesses) by any application. Such a sharing mechanism, and other exemplary sharing configurations across multiple enterprise applications, are later discussed in FIG. 2.

FIG. 1C depicts a flow chart 1C00 for managing a project having heterogeneous project data. The shown steps can be followed by a project manager or administrator. The shown steps are purely exemplary and other approaches are possible.

As shown, the flow commences when a user associates an alert with a user-defined basis amount or logical outcome such as an account basis value (see operation 181). Having such a user-defined basis value, the user can associate any number of threshold values with the user-defined basis value or logical outcome (see operation 183). An alert is raised if the For example, if the basis value comprising the sum of the cost (e.g., recorded in euros) of a daily material use by the German team and the costs of the daily material use by the Chinese (e.g., recorded in RMB) team exceeds a threshold of $20,000 USD (the basis value), then raise an alert.

A particular alert might be configured to apply to multiple accounts, and/or to a range of accounts. Accordingly a user might identify an account or range of accounts to which the alert applies (see operation 185). Processing continues when the system evaluates the account or range of accounts to which the alert applies (see operation 187), and a GUI or other human interface displays a visual indicator for accounts that are in an alert state. In addition to a visual alert and/or an audio alert, (see operation 188) some situations admit propagation of a visual alert and/or an audio alert to be emitted upon user navigation to an account summary (see operation 189). In some cases, the summary display might comprise a display of multiple accounts in an alert state. Visual alert indications can be applied to multiple accounts in a summary screen, or can be applied to multiple rows in an account display. In this manner, even projects that comprise thousands of accounts can be managed inasmuch as the summary screen can show only accounts that need attention (e.g., accounts that are in an alert state).

FIG. 2 depicts a system 200 including multiple enterprise applications and a project management application that share account data for implementing project management alerts using heterogeneous project data. As an option, one or more instances of system 200 or any aspect thereof may be implemented in the context of the architecture and functionality of the embodiments described herein. Also, the system 200 or any aspect thereof may be implemented in any desired environment.

As shown, enterprise applications take in inputs 202 (e.g., purchase events, payment events, invoices, etc.) and performs one or more processing steps on the inputs (e.g., see account transaction 204) and produces outputs 206, which can be stored in appropriate accounts 232. An enterprise application may include facilities to display account data in account views (e.g., account view A, account view B, etc.), and may further comprise facilities to present reports (e.g., see enterprise application reports 240).

The data items stored by the enterprise applications can be accessed by a project management application 104, which in turn comprises an alert processor 210 and alert logic 132. Alert logic 132 can access configuration data (e.g., config 140₁) and can process data items and raise alerts in accordance with the configuration data. A project management application may include facilities to display project management data in account views (e.g., account view A, account view B, etc.) and/or a summary view (e.g., summary 130), and may further comprise facilities to present reports (e.g., see project management reports 230).

The aforementioned project management reports can be configured to alert the user when any data item in the project reaches or exceeds a given value (e.g., a threshold value). And/or project management reports can be configured to alert the user when any combination of data items in the project reaches or exceeds a given value. When a combination is used, the local units used for the stored data item value can be normalized to account for differences in the local units.

Returning to the example of FIG. 1A, the alert logic 132 triggers an alert when the spending is ≧$10. In this example, the spending limit would be triggered even when only spending is 8 euros (e.g., based on an exchange rate of 1 EURO=1.36 USD).

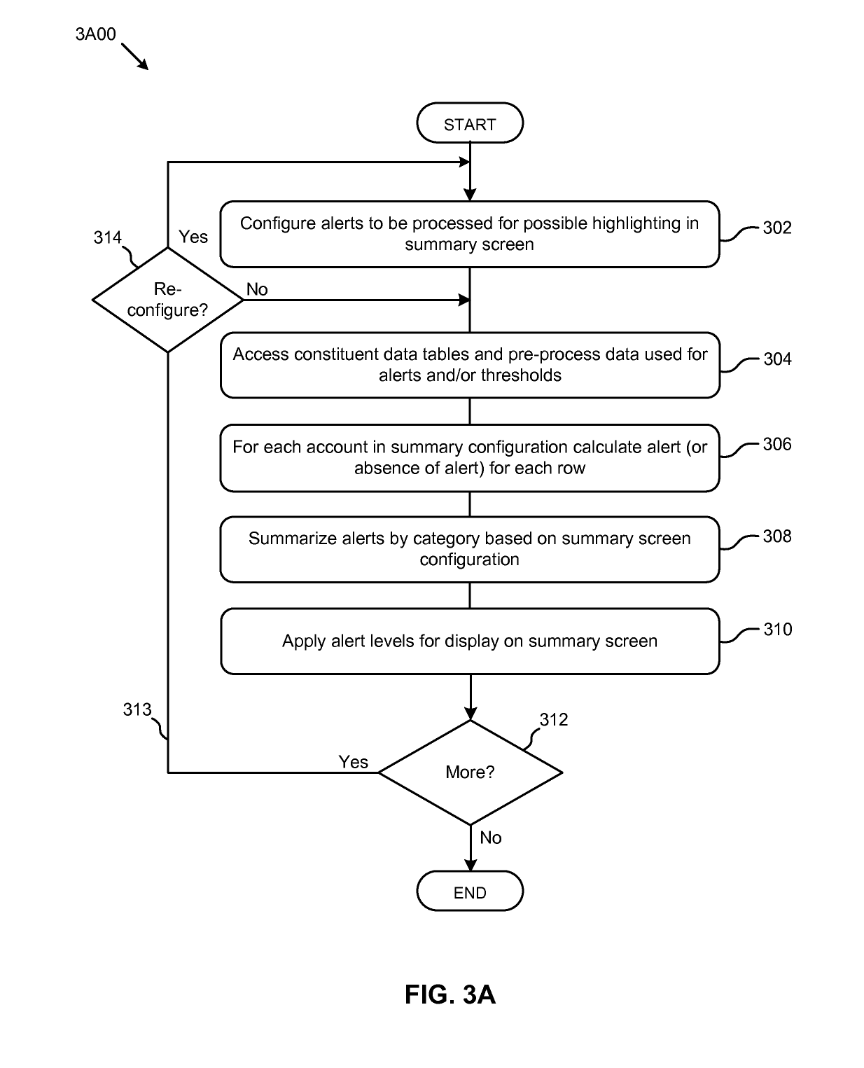

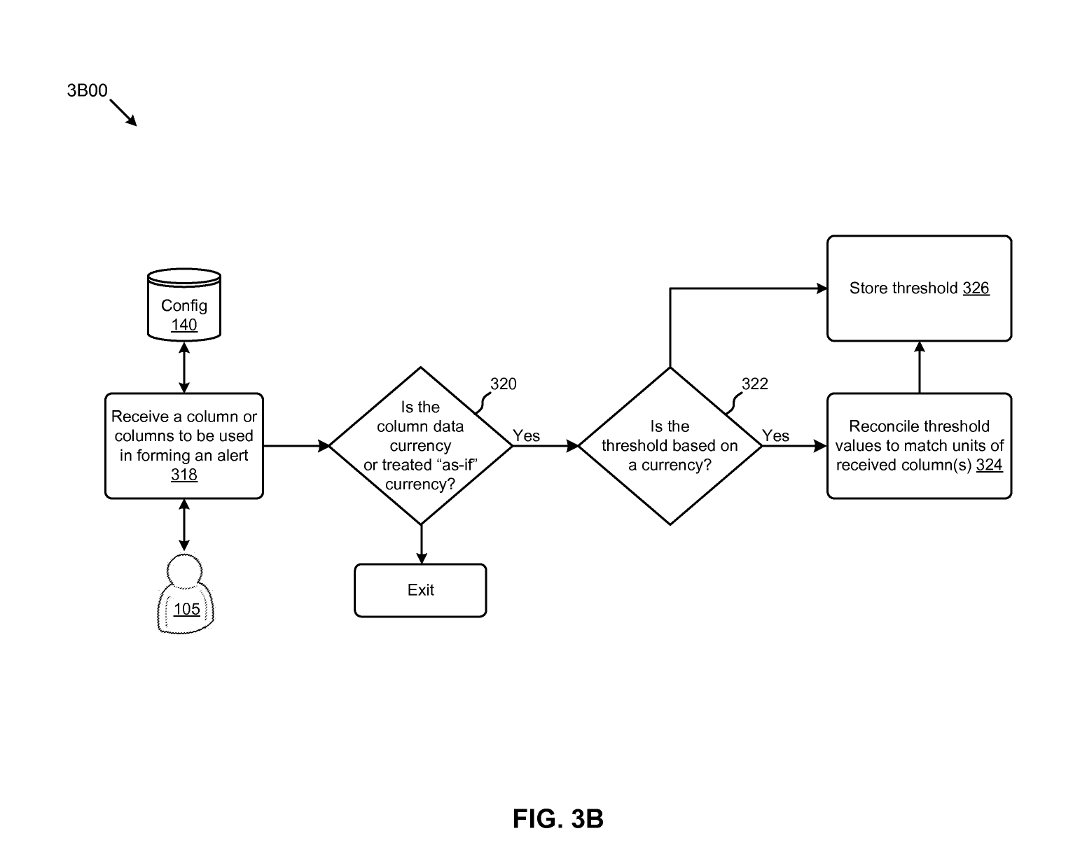

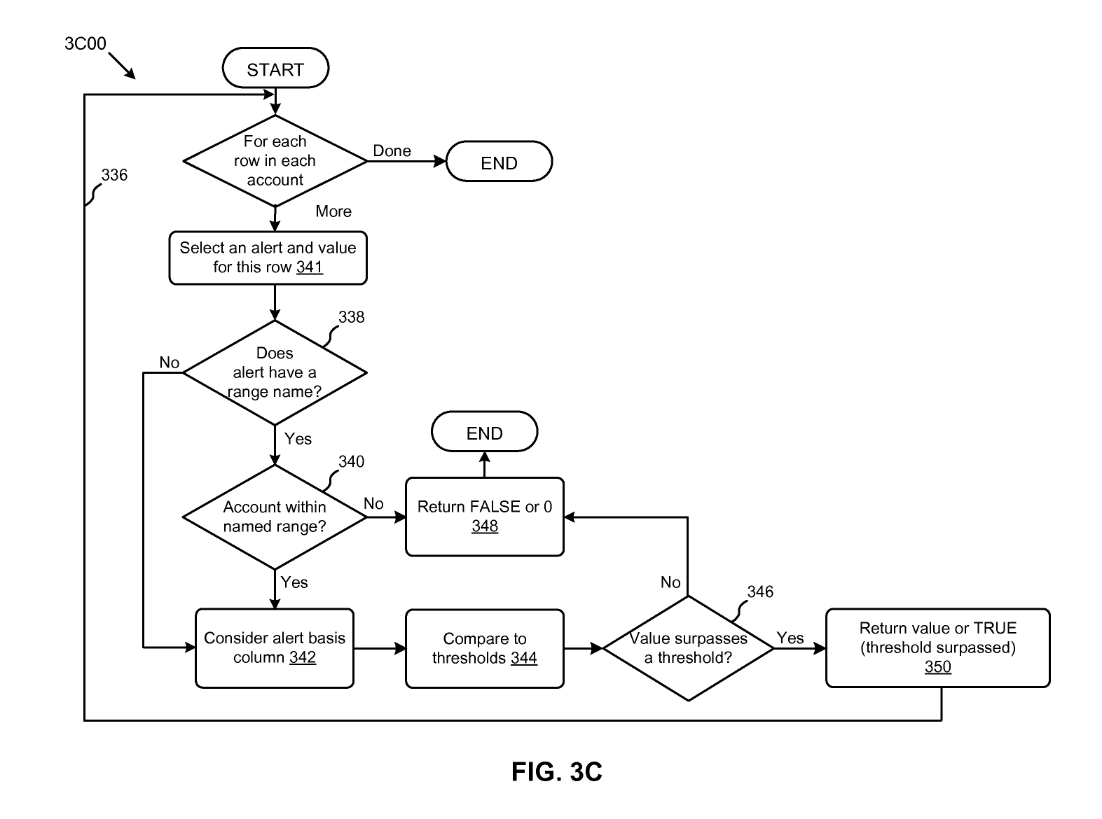

The foregoing describes techniques to calculate and trigger an alert. Additional techniques can be employed, including techniques to raise an alert and display or otherwise indicate that a project-wise data item value or threshold has been reached or surpassed. Such additional techniques are shown and described as pertaining to FIG. 3A through FIG. 3C.

FIG. 3A depicts a flow 3A00 used in systems for implementing project management alerts using heterogeneous project data. As an option, one or more instances of flow 3A00 or any aspect thereof may be implemented in the context of the architecture and functionality of the embodiments described herein. Also, the flow 3A00 or any aspect thereof may be implemented in any desired environment.

As shown, the flow commences upon configuration of alerts to be considered as the project progresses (see operation 302). Then, in a loop, an alert processor accesses constituent data tables and pre-processes data used for calculating and raising alerts (see operation 304). For example, a currency data item in an account might need to be converted into a normalized currency (e.g., YEN to DOLLAR). For each account in the summary configuration, the flow processes each row in the account and calculates an alert or the fact that there is no alert (see operation 306). An alert can be raised at that moment in time, or a set of alerts can be held until such a time as the alerts can be categorized. The shown operation 308 serves to summarize alerts by category based on a summary screen configuration. Such a configuration may include alert levels such as “critical”, “urgent”, “warning”, etc. (see operation 310) and the level of any given alert can be presented using a visual indication in a summary screen.

If there are more accounts in a project, or more projects to summarize, decision 312 is taken to path 313, and the flow from operation 304 to operation 310 executes again. In some cases, a user might want to change configuration settings, and in such a case decision 314 is taken to again perform configuration steps (see operation 302). Such configuration can include specification of a common currency, and/or currency rate tables, and/or currency thresholds. In some cases, a data item (e.g., a column in a table) can be regarded as a currency or can be treated “as if” it is a currency (e.g., observing conversion rules and conversion table). Such cases are presently discussed.

FIG. 3B depicts an operation flow 3B00 based on a received object as used to form project management alerts using heterogeneous project data. As an option, one or more instances of operation flow 3B00 or any aspect thereof may be implemented in the context of the architecture and functionality of the embodiments described herein. Also, the operation flow 3B00 or any aspect thereof may be implemented in any desired environment.

The operation flow 3B00 commences upon receipt of an indication of a column to be used in forming an alert (see operation 318). Such an indication can arise from a user or from configuration data (e.g., see config 140). Decision 320 determines if the column indicated is a currency value (or if it is intended to be treated as a currency value). If so, a corresponding threshold is retrieved (e.g., from a user or from configuration data) and decision 322 determines if the threshold is based on a currency. If so, processing continues to operation 324 to reconcile threshold values to match units of the received columns. Once reconciled, the threshold is stored (see operation 326) and the alert logic will raise an alert when the threshold is reached or surpassed.

In other cases, the alert is to be raised when a data item value is found to be outside of a given range. Some examples of range processing are included in the discussion of FIG. 3C.

FIG. 3C depicts an operation flow 3C00 to evaluate account data items as used when forming project management alerts using heterogeneous project data. As an option, one or more instances of operation flow 3C00 or any aspect thereof may be implemented in the context of the architecture and functionality of the embodiments described herein. Also, the operation flow 3C00 or any aspect thereof may be implemented in any desired environment.

The flow receives a set of tables or accounts, comprising heterogeneous project data, and portion of the flow is iterated over a set of tables or accounts. As shown in loop 336, for each of a set of given accounts, processing is performed over all rows of the account until done. While there remain more rows to process, the operation 341 determines if there is an alert on a column or cell, and if so, selects the alert and corresponding value before proceeding to decision 338. Decision 338 determines if the alert should be processed against a named range of accounts. In the situation as shown, the determination as to if the alert and value should be processed against a range specification can be determined based on the existence of a pre-configured range name. If the alert does have a range name, then the account identification is compared with the bounds as described by the pre-configured named range, and if the account identification outside of the bounds of the range (see operation 340), then the selected alert does not apply (see operation 348). Otherwise, the selected value and alert basis considered (see operation 342), and compared using thresholds (see operation 344) to determine if the value surpasses the threshold (see operation 346), and if so, an alert is raised for this value and the flow returns TRUE (see operation 350). There are many situations when a value is subjected to multiple thresholds, yet there is a basis or reasoning why an alert is not raised. Examples include situations where a first-tested value (e.g., an instantaneous value) surpasses a first threshold, yet a second tested value (e.g., a daily limit) is not surpassed. Such situations can be captured in an alert basis column.

An alert can be created to evaluate against not only a single value (e.g., a value from a single account ledger balance), but also, an alert can fire based on evaluation of user-defined formulas which operate over values retrieved from or derived from multiple account ledgers and/or based on other numeric or logical factors.

In any of the aforementioned cases, an alert basis column value is compared to its corresponding threshold or thresholds (see operation 344), and when the compared value surpasses one or more of its corresponding thresholds (see decision 346) then the flow returns TRUE (see operation 350). In some cases surpassing a threshold and raising an alert occurs when a value exceeds a threshold (e.g., in the case of a maximum spending limit). In other cases surpassing a threshold and raising an alert occurs when a value is smaller than a threshold (e.g., in the case of a minimum amount of materiel remaining). In some cases, a threshold is based on account or ledger or value being denominated in a particular currency.

Such cases of a minimum threshold or a maximum threshold or range bound can be configured and stored in configuration data. Illustrative embodiments of a configuration flow are presently discussed.

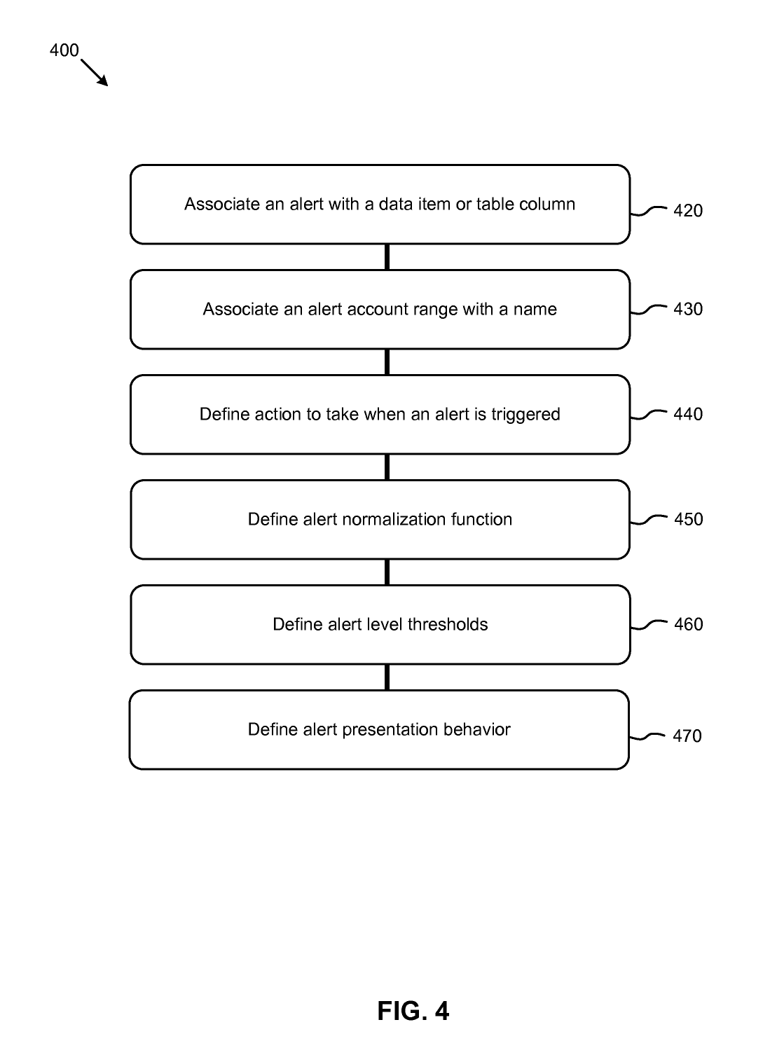

FIG. 4 depicts a configuration flow 400 used to configure project management alerts using heterogeneous project data. As an option, one or more instances of configuration flow 400 or any aspect thereof may be implemented in the context of the architecture and functionality of the embodiments described herein. Also, the configuration flow 400 or any aspect thereof may be implemented in any desired environment.

As shown, the configuration flow 400 commences when a user or system associates a data item with an alert (see operation 420). An alert can comprise many characteristics, some of which are described in FIG. 4. For example, an alert can be associated with an account, and the account and/or a constituent column can further be associated with a range. Still further, such a range can be named (see operation 430).

When an alert value is deemed to be outside of a range, or the alert value is deemed to have surpassed a threshold, then an alert is triggered, and the triggering event can be associated with additional actions (see operation 440). As earlier discussed, some data item values are deemed to be currency or to be handled “as if” they are currency. As such, configuration flow 400 supports the specification of a normalization function (see operation 450). Any of the aforementioned thresholds or range bounds can be associated with an alert level (see operation 460). For example, if a spending limit exceeds a low threshold, then a warning alert is raised. However, if a spending limit exceeds a high threshold, then an urgent or critical alert is raised.

The configuration flow 400 also supports specification of how to present an alert. For example, a warning alert might be color coded as yellow, or an urgent or critical alert might be color coded as red. In some cases the event of raising an alert is accompanied with an emitted audio signal, e.g., a beep or screech, etc. (see operation 470).

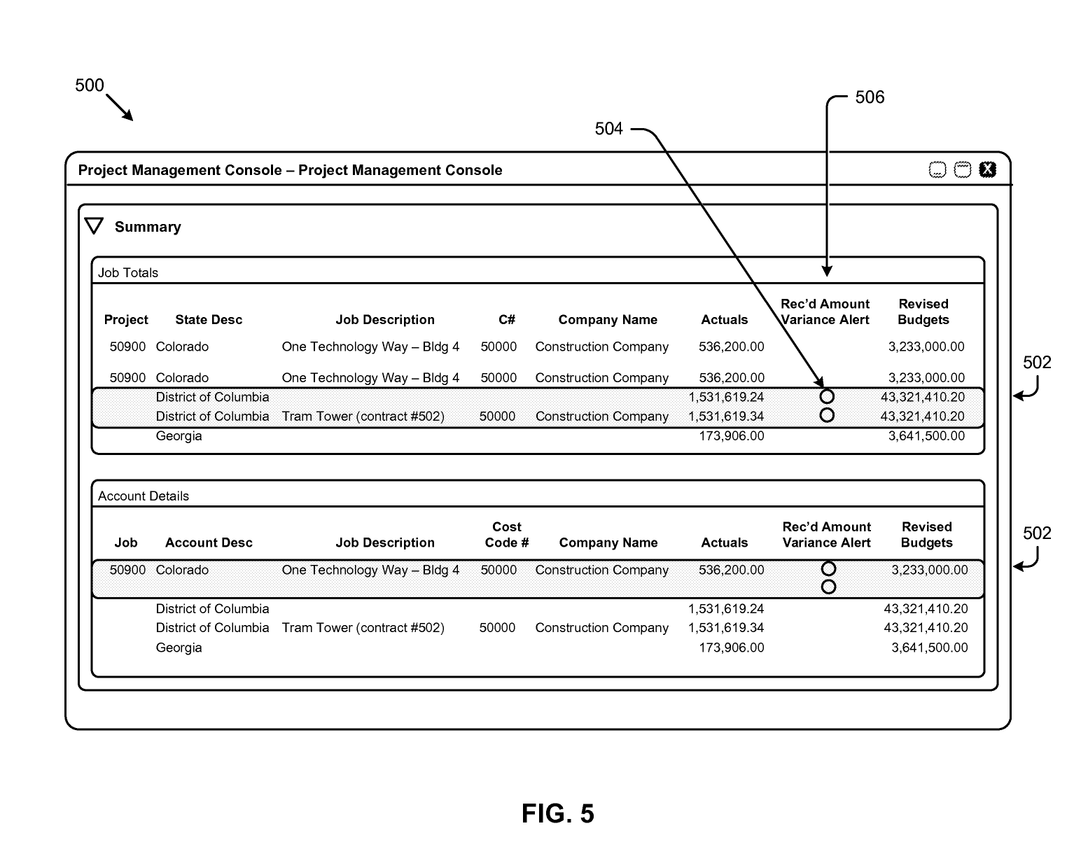

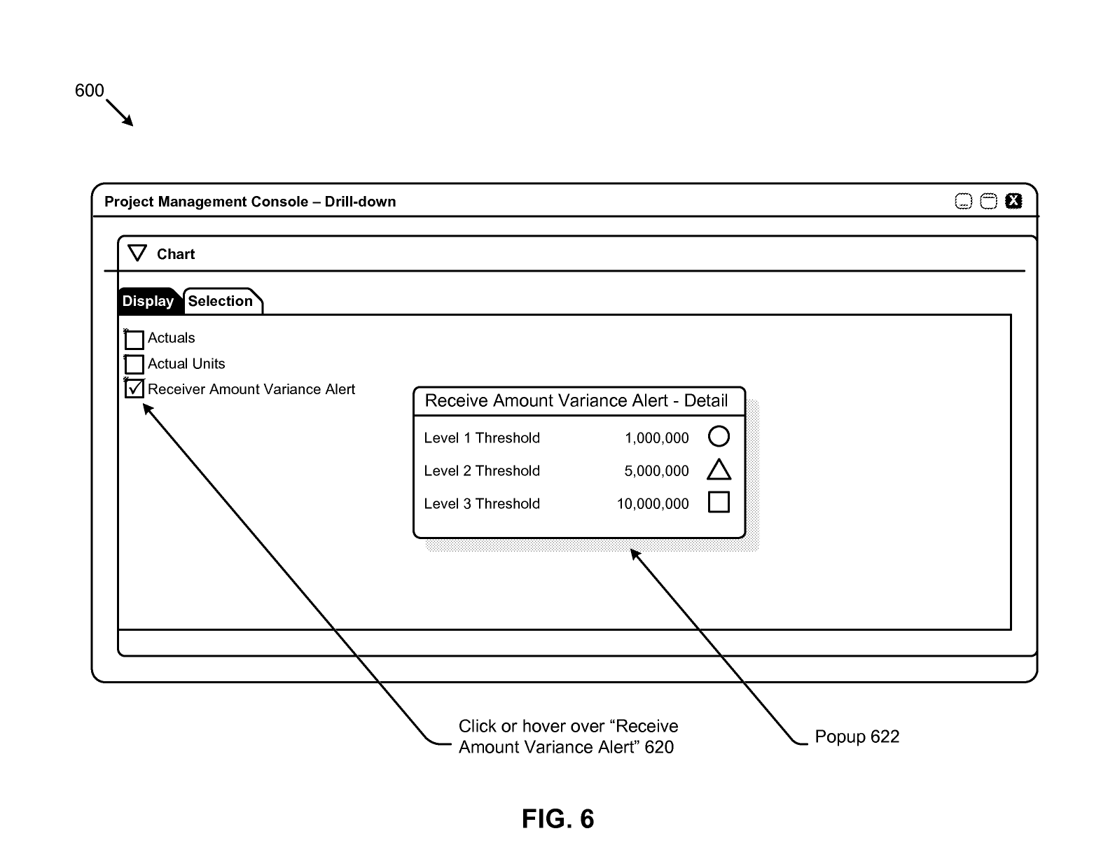

Many presentation techniques are possible, and a sample of such techniques are shown and discussed in the following FIG. 5 and FIG. 6.

FIG. 5 is a screen display 500 showing alerts in the form of row highlights as used in displays output from systems implementing project management alerts using heterogeneous project data. As an option, one or more instances of screen display 500 or any aspect thereof may be implemented in the context of the architecture and functionality of the embodiments described herein. Also, the screen display 500 or any aspect thereof may be implemented in any desired environment.

As shown, a screen display 500 includes a project management console comprising a listing of a large number of accounts. Some of the highlighted rows 502 include visual indicators in the form of icons 504 in a variance alert column 506. Some embodiments support an alert summary screen such that a user can view a summary of alerts, and can drill-down into detail of any selected alert. An example is presented in FIG. 6.

FIG. 6 is a screen display 600 showing a summary of alerts including a pop-up as used with systems implementing project management alerts using heterogeneous project data. As an option, one or more instances of screen display 600 or any aspect thereof may be implemented in the context of the architecture and functionality of the embodiments described herein. Also, the screen display 600 or any aspect thereof may be implemented in any desired environment.

As shown, the screen display 600 presents a summary of alerts, each alert with a corresponding checkbox. A user can click the checkbox to retrieve alert details for any of the alerts. Alternatively, and as shown, a user might indicate (e.g., using a pointing device over the label of an alert or its checkbox) a desire to see detail of the alert (e.g., thresholds), and a pop-up window 622 presents such alert details (see operation 620).

### Additional Embodiments of the Disclosure

### Additional Practical Application Examples

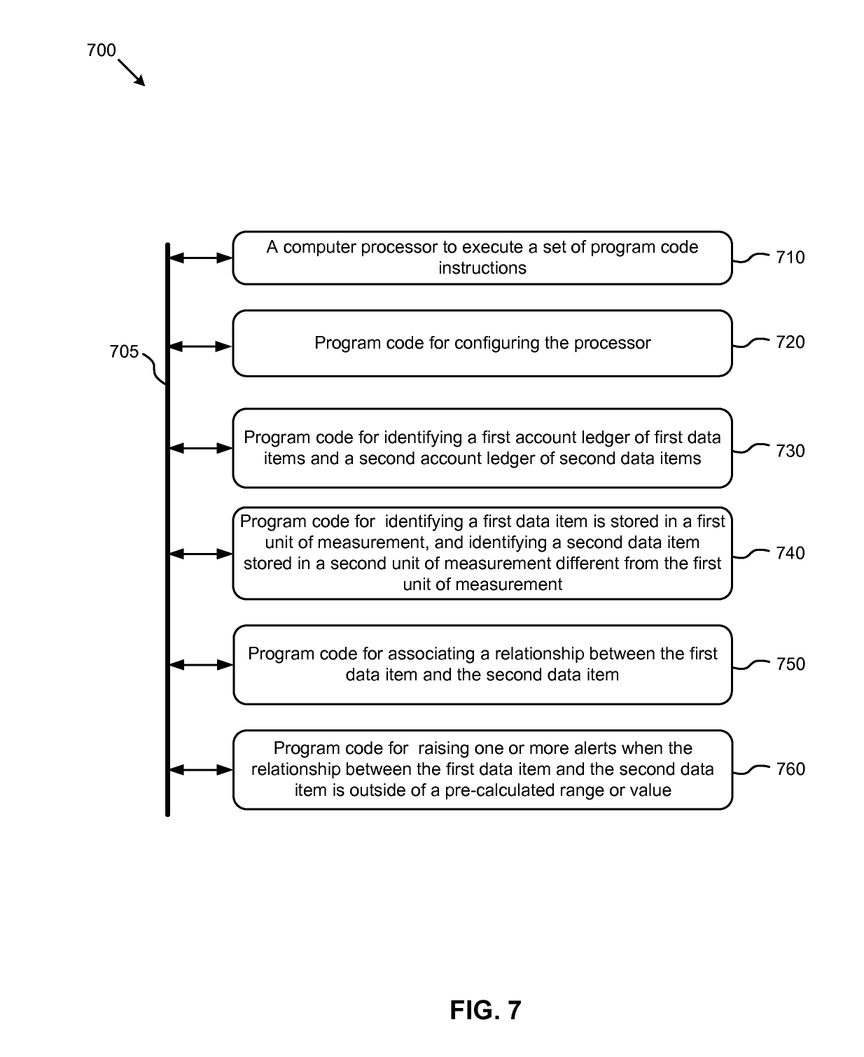

FIG. 7 is a block diagram of a system for project management alerts using heterogeneous project data, according to some embodiments. As an option, the present system 700 may be implemented in the context of the architecture and functionality of the embodiments described herein. Of course, however, the system 700 or any operation therein may be carried out in any desired environment. As shown, system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims. The embodiment of FIG. 7 implements a portion of a computer system, shown as system 700, comprising a computer processor to execute a set of program code instructions (see module 710) and modules for accessing memory to hold program code instructions to perform: configuring the processor (see module 720); identifying a first account ledger of first data items and a second account ledger of second data items (see module 730); identifying a first data item is stored in a first unit of measurement, and identifying a second data item stored in a second unit of measurement different from the first unit of measurement (see module 740); associating a relationship between the first data item and the second data item (see module 750); and raising one or more alerts when the relationship between the first data item and the second data item is outside of a pre-calculated range or value (see module 760).

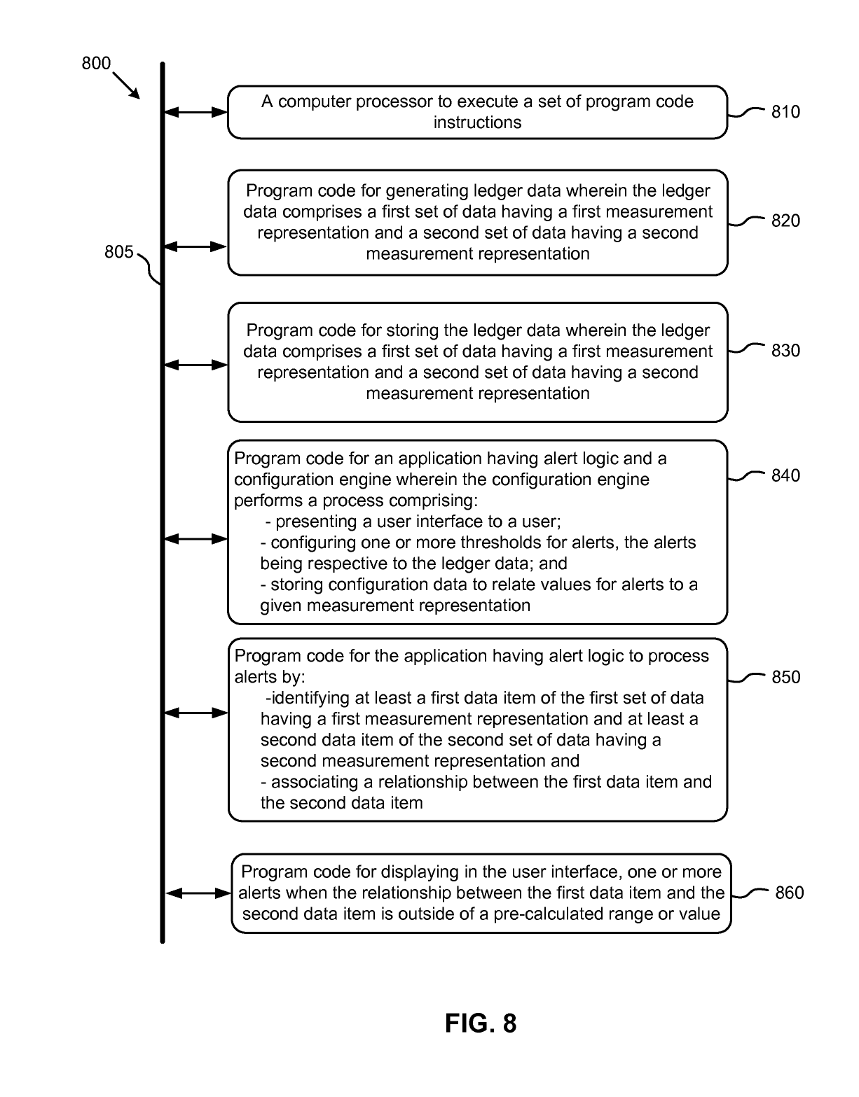

FIG. 8 is a block diagram of a system for project management alerts using heterogeneous project data, according to some embodiments. As an option, the present system 800 may be implemented in the context of the architecture and functionality of the embodiments described herein. As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The embodiment of FIG. 8 implements a portion of a computer system, shown as system 800, comprising a computer processor to execute a set of program code instructions (see module 810) and modules for accessing memory to hold program code instructions to perform: generating ledger data wherein the ledger data comprises a first set of data having a first measurement representation and a second set of data having a second measurement representation (see operation 820), then storing the ledger data (see module 830) to be accessible by an application having alert logic and a configuration engine (see module 840). The configuration engine serves to present a user interface to a user, then configures one or more thresholds for alerts and storing configuration data to relate values for alerts to a given measurement representation. The shown embodiment further uses the alert logic to process alerts by identifying a first data item of the first set of data having a first measurement representation and a second data item of the second set of data having a second measurement representation to associate a relationship between the first data item and the second data item (see module 850). In this and other exemplary cases, a display unit is provided for displaying one or more alerts when the relationship between the first data item and the second data item is outside of a pre-calculated range or value (see module 860).

### System Architecture Overview

### Additional System Architecture Examples

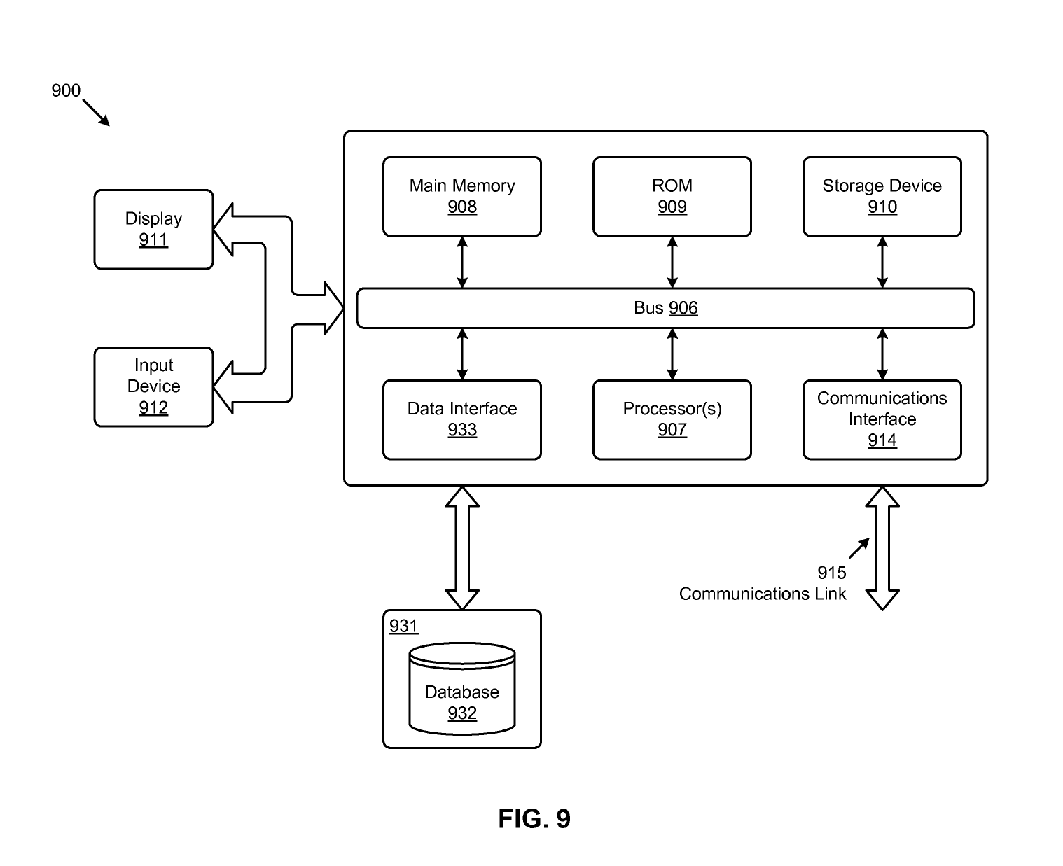

FIG. 9 depicts a block diagram of an instance of a computer system 900 suitable for implementing an embodiment of the present disclosure. Computer system 900 includes a bus 906 or other communication mechanism for communicating information, which interconnects subsystems and devices, such as a processor 907, a system memory 908 (e.g., RAM), a static storage device (e.g., ROM 909), a disk drive 910 (e.g., magnetic or optical), a data interface 933, a communication interface 914 (e.g., modem or Ethernet card), a display 911 (e.g., CRT or LCD), input devices 912 (e.g., keyboard, cursor control), and an external data repository 931.

According to one embodiment of the disclosure, computer system 900 performs specific operations by processor 907 executing one or more sequences of one or more instructions contained in system memory 908. Such instructions may be read into system memory 908 from another computer readable/usable medium, such as a static storage device or a disk drive 910. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 907 for execution. Such a medium may take many forms, including but not limited to, non-volatile media and volatile media. Non-volatile media includes, for example, optical or magnetic disks, such as disk drive 910. Volatile media includes dynamic memory, such as system memory 908.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 900. According to certain embodiments of the disclosure, two or more computer systems 900 coupled by a communications link 915 (e.g., LAN, PTSN, or wireless network) may perform the sequence of instructions required to practice the disclosure in coordination with one another.

Computer system 900 may transmit and receive messages, data, and instructions, including programs (e.g., application code), through communications link 915 and communication interface 914. Received program code may be executed by processor 907 as it is received, and/or stored in disk drive 910 or other non-volatile storage for later execution. Computer system 900 may communicate through a data interface 933 to a database 932 on an external data repository 931. A module as used herein can be implemented using any mix of any portions of the system memory 908, and any extent of hard-wired circuitry including hard-wired circuitry embodied as a processor 907.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A computer implemented method comprising:
generating ledger data wherein the ledger data comprises a first set of data having a first measurement representation and a second set of data having a second measurement representation;
storing the ledger data wherein the ledger data comprises a first set of data having a first measurement representation and a second set of data having a second measurement representation;
using an application having alert logic and a configuration engine wherein the configuration engine performs a process comprising:
presenting a user interface to a user;
configuring one or more thresholds for alerts, the alerts being respective to the ledger data; and
storing configuration data to relate values for alerts to a given measurement representation;
using the application having alert logic to process alerts by:
identifying at least a first data item of the first set of data having a first measurement representation and at least a second data item of the second set of data having a second measurement representation; and
associating a relationship between the first data item and the second data item; and
displaying in the user interface, one or more alerts when the relationship between the first data item and the second data item is outside of a pre-calculated range or value.

2. The method of claim 1, wherein the relationship between the first data item and the second data item comprises at least one of a first alert threshold value, a second alert threshold value, and a third alert threshold value.

3. The method of claim 2, wherein an alert threshold value comprises an account balance.

4. The method of claim 1, wherein the relationship between the first data item and the second data item comprises a currency exchange rate.

5. The method of claim 1, wherein identifying a first ledger comprises selecting an alert and determining an account or range of accounts to which the alert is associated.

6. The method of claim 1, wherein the relationship between the first data item and the second data item is determined using a user defined formula.

7. The method of claim 1, further comprising a visual display to show an occurrence of an alert state in a row-column format.

8. The method of claim 7, wherein the visual display is filtered to display only accounts that are in an alert state.

9. The method of claim 1, wherein an occurrence of an alert state causes display of at least one of, the first data item in the first unit of measurement and the second data item in the second unit of measurement.

10. The method of claim 1, wherein identifying a first account ledger and identifying a second account ledger is performed by using an account range.

11. A computer program product embodied in a non-transitory computer readable medium, the computer readable medium having stored thereon a sequence of instructions which, when executed by a processor causes the processor to execute a process, the process comprising:
generating ledger data wherein the ledger data comprises a first set of data having a first measurement representation and a second set of data having a second measurement representation;
storing the ledger data wherein the ledger data comprises a first set of data having a first measurement representation and a second set of data having a second measurement representation;
using an application having alert logic and a configuration engine wherein the configuration engine performs a process comprising:
presenting a user interface to a user;
configuring one or more thresholds for alerts, the alerts being respective to the ledger data; and
storing configuration data to relate values for alerts to a given measurement representation;
using the application having alert logic to process alerts by:
identifying at least a first data item of the first set of data having a first measurement representation and at least a second data item of the second set of data having a second measurement representation; and associating a relationship between the first data item and the second data item; and
displaying in the user interface, one or more alerts when the relationship between the first data item and the second data item is outside of a pre-calculated range or value.

12. The computer program product of claim 11, wherein the relationship between the first data item and the second data item comprises at least one of a first alert threshold value, a second alert threshold value, and a third alert threshold value.

13. The computer program product of claim 12, wherein an alert threshold value comprises an account balance.

14. The computer program product of claim 11, wherein the relationship between the first data item and the second data item comprises a currency exchange rate.

15. The computer program product of claim 11, wherein identifying a first ledger comprises selecting an alert and determining an account or range of accounts to which the alert is associated.

16. The computer program product of claim 11, wherein the relationship between the first data item and the second data item is determined using a user defined formula.

17. The computer program product of claim 11, further comprising instructions to present a visual display to show an occurrence of an alert state in a row-column format.

18. The computer program product of claim 11, wherein an occurrence of an alert state causes display of at least one of, the first data item in the first unit of measurement and the second data item in the second unit of measurement.

19. A system comprising:
a storage device to store ledger data wherein the ledger data comprises a first set of data having a first measurement representation and a second set of data having a second measurement representation;
a configuration engine wherein the configuration engine performs a process comprising:
presenting a user interface to a user;
configuring one or more thresholds for alerts, the alerts being respective to the ledger data;
configuring a relationship between a first data item of the ledger data and a second data item of the ledger data; and
storing configuration data to relate values for alerts to a given measurement representation;
an application to process the first data item of the ledger data and a second data item of the ledger data wherein the first data item is stored in a first unit of measurement, and the second data item is stored in a second unit of measurement different from the first unit of measurement; and
alert logic to raise one or more alerts when the relationship between the first data item and the second data item is outside of a pre-calculated range or value.

20. The system of claim 19, wherein the relationship between the first data item and the second data item comprises at least one of a first alert threshold value, a second alert threshold value, and a third alert threshold value.
